(19) United States
(12) Patent Application Publication
(10) Pub. No.: US 2023/0113624 A1
(43) Pub. Date: Apr. 13, 2023

(54) Egg Product, Apparatus and Manufacture Process

(71) Applicant: Protemach Inc., Canoga Park, CA (US)

(72) Inventor: Ed Moshaver, Beverly Hills, CA (US)

(73) Assignee: Protemach Inc., Canoga Park, CA (US)

(21) Appl. No.: 17/497,956

(22) Filed: Oct. 10, 2021

(51) Int. Cl. A23L 15/00; A23L 5/10

(52) U.S. Cl. CPC A23L 15/00; A23L 5/10

(57) ABSTRACT

A process for producing an egg product such as egg white product from raw egg. Uniformed and blended liquid egg white fills in a casing. Agitation maintains the uniformed egg white and reduces aeration of the uniformed egg white. The nonaerated uniformed egg white is cooked in the casing. Cooking is carried out by heating. An edible egg white product in a casing is manufactured, and is essentially free of preservatives or food fillers, selectively being free of starch, flour, and gum.

### BACKGROUND

The present disclosure relates to an egg product, particularly an egg white product, apparatus, and manufacturing process for filling in casings with raw egg white or egg yolk.

More particularly, it relates to marketable ready-to-eat egg white products or egg yolk products and processes for manufacturing that product which can be available to consumers, restaurants, institutional, and grocery trades.

Efforts to produce palatable cooked egg white without adding any food fillers such as starches, gums, etc., have not been successful.

### SUMMARY

The present disclosure provides a palatable Ready to Eat egg white or egg yolk or combination of white and yolk product.

More so there is a product, method of manufacturing and an apparatus for filling egg white or egg yolk or combination of white and yolk in plastic casings.

Another aspect of the disclosure is to provide an egg white product in the form of a flowable uniform dispersion in a plastic casing.

Another aspect is to provide an egg white product which can be heated preparatory to eating without resulting in toughness, undesirable exudation of white material, and without microwave explosive effects.

The disclosure provides an egg white and egg yolk product and a process especially adapted for producing the product.

The process produces an egg white and egg yolk product which is uniformed and flowable prior to cooking, and after cooking is in the form of a filled casing.

The process produces an egg white and egg yolk product which has the tenderness, texture and eating properties of natural cooked egg whites or egg yolks.

The processing of the egg white material includes heat treatment to achieve fully cooked, ready to eat egg whites or egg yolks.

The present disclosure provides an egg white and egg yolk product that can be marketed to the restaurant, institutional, grocery or consumer trades., and end consumers.

Additional features of the disclosure will appear from the following description in which the embodiments have been set out in conjunction with the accompanying drawings.

### DRAWINGS

FIG. 1 is a flow diagram illustrating the general procedures for carrying out the disclosed process. The process can be for egg white alone, egg yolk alone or a combination of egg white and egg yolk.

FIG. 2 is a flow diagram illustrating the general procedures of an alternative process of the disclosure. The process can be for egg white alone, egg yolk alone or a combination of egg white and egg yolk.

FIG. 3 is a view of an apparatus for blending the egg white/egg yolk to obtain a uniformed liquid. Agitation is affected to the blended egg product to remove air from the liquid egg product and render the liquid egg product essentially nonaerated. This includes a process or procedure where, the egg white flows from the hopper into the rotating gears which are inside the blender, the egg whites pass through rotating gears in the blender. The gears act to push the egg white against the gear surfaces and act to spread the molecules of protein of the egg white with the water in the egg white to achieve a uniformed mix without aeration. This uniformed mix without aeration caused by the gear interaction would also operate with egg yolk alone and with a combination of egg white and egg yolk as selected and desired. The blending apparatus and blending process can be for egg white alone, egg yolk alone or a combination of egg white and egg yolk as selected and desired.

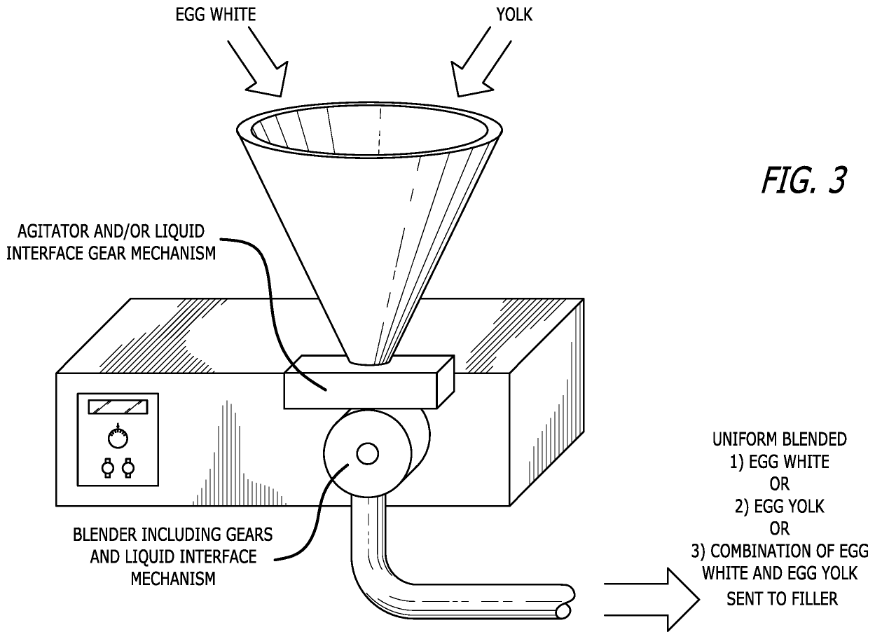

FIG. 4 is a view of the filling apparatus.

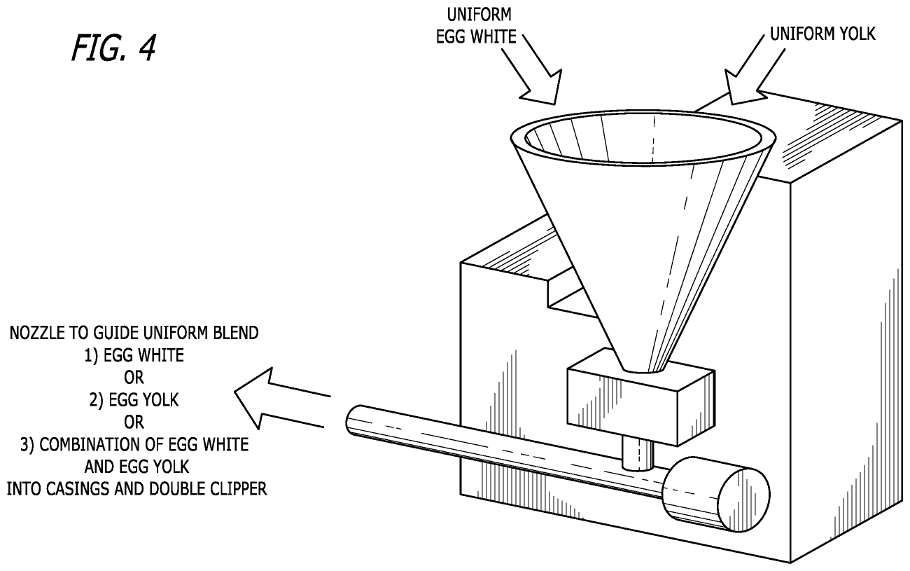

FIG. 5 is a view of the closing apparatus (double clipper machine) showing an operation of filling in casings with egg white/egg yolk. The closing apparatus and closing process can be for egg white alone, egg yolk alone or a combination of egg white and egg yolk as selected and desired.

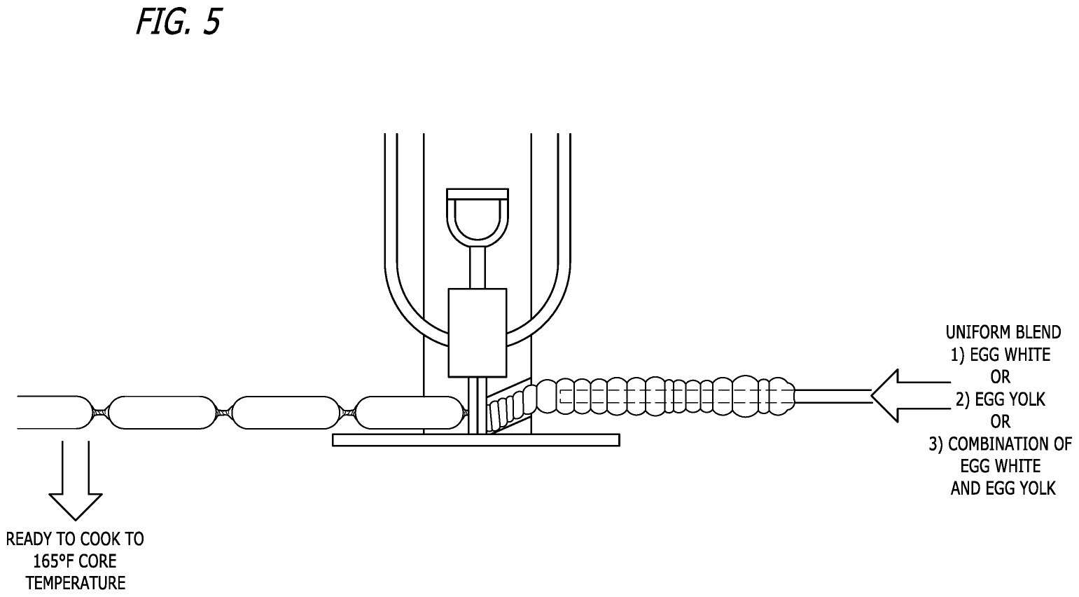

### DESCRIPTION

The disclosure relates to filling a film casing with a raw egg product and preventing air from entering into the film casing. Then cooking such egg products in the casing. The egg product has no additives or food fillers, such as starches, or flour, or gum which would affect consistency of the product, and/or palatability or desirability for a consumer. There may be one or more vegetable or meat flavorings if desirable for taste. The cooked end egg product is a natural egg product with an acceptable shelf life. Ideally the product should be retained in a cool environment prior to consumption, which can be at room temperature or heated or otherwise selectively prepared by a consumer according to individual taste preferences. The egg products may be heat treated in autoclaves under 254 degrees Fahrenheit (° F.) and about 2 atmospheres fora period of about 45 to 60 minutes. The result would be a shelf stable product, without a need for refrigeration. As such the cooking would be performed in the autoclave, and the shelf life could go up to 12 months. Certain egg products might be less than 3 months shelf life without a cooler.

The disclosure relates to a process that produces an egg white/egg yolk product from raw egg separated from egg yolk, or egg yolks from egg. There are the steps of rendering liquid egg white and/or egg yolk uniform, applying blending to achieve and maintain the uniform egg white and/or egg yolk uniform and reduce aeration of the uniform egg white and/or egg yolk, filling in casings with the uniform egg white and/or egg yolk, and cooking the non-aerated uniform egg white and/or egg yolk in the casing, without adding any additives or food fillers. Salt or other flavors can be added for taste. A secondary effect could be to add shelf life as a preservative in some cases.

The disclosure relates to a process for producing an egg white product from liquid egg white comprising the steps of rendering a uniform supply of liquid egg white. Blending is applied to the liquid egg white prior to filling the liquid egg white in a casing, reducing aeration of the uniform egg white, filling the casing with the blended non-aerated liquid egg white, and cooking the uniform blended non-aerated liquid egg white in the casing.

The cooking is carried out by heating at a temperature of between about 190° F. and about 240° F. selectively to reach a minimum of 165° F. or higher (for example, up to 185° F.) of the core of the product in the casing. The liquid egg white is blended and agitated to minimize aeration, the measure of aeration being about 0% air relative to a volume of liquid egg white is better. In some cases, selectively up to 2% or 5% or 8% air in the volume of liquid egg white might be acceptable for some formats of the end product. Blending is affected at a temperature between about 32° F. and about 43° F. and at a speed between 500 rpm and 1000 rpm. Cooking is affected by heating at a temperature of about 190° F. to 240° F. for about one to three hours to reach a minimum core temperature of 165° F. to 185° F. of the product in the casing.

The disclosure also includes a process for producing an egg yolk product from raw liquid egg yolk. The egg yolk is separated from the liquid egg and rendered as a uniform liquid egg yolk. Blending and agitating the uniform liquid egg yolk reduces aeration of the liquid egg yolk prior to filling egg yolk in a casing. The casing is with the blended non aerated egg yolk, and the uniform blended non-aerated egg yolk is cooked in the casing.

The disclosure also includes a process for producing an egg product from raw egg comprising the steps of rendering uniform liquid egg white and egg yolk. Blending is affected prior to filling into a casing. The uniform blended egg white and egg yolk is agitated to reduce aeration of the egg white and egg yolk. The casing is filled with the blended non aerated egg white and egg yolk, and the uniform blended non-aerated egg white and egg yolk is cooked in the casing.

The process and product are essentially free of food fillers, selectively being free of at least one or two or all of starches, flour, or gum. The process and product are essentially free of preservatives. Where salt is used the preservative effect is secondary. The salt is for enhancing taste, as may be desired.

The disclosure also includes the product produced by the processes disclosed.

The egg white is adequately fully/completely blended when there is an essentially uniform mix of water and protein. By this “uniformity” it is meant that the protein and water essentially bind together and do not easily get separated. Since this binding does not last for a long time, cooking the blended mix with packing in the casing is completed preferably as soon as blending (and air removal) is complete and within about 8 to about 10 hours.

Blending and mixing should be with a certain rotation of mechanical gears in the blender and the speed should be between about 500-1000 rpm. The blending actually is performed quickly, like within seconds when the egg white passes through the rotating gears in the blending machine, before passage to the filling machine. The total time for 40 lbs. of egg white to be rendered uniform in the blender would be about 2-5 minutes.

Blending in our blender by a single pass through is essentially sufficient to reach desired consistency, and this is verified after cooking, and quality control of the final product. A viscometer would verify this as needed. Essentially the egg prior to filing the casing is uniform and air-free (namely non aerated) egg white to stuff into the casings.

The egg white or egg yolk is adequately, fully, or completely free of air by review of the finished product. The process involved visual and tactile inspection of the first couple of portions of a casing filling run. The first filled casings may have air and are not acceptable as final products. When visually and by touching, the casing is determined to be firm and to have little or no air, then the product is an acceptable in the casing that is then clipped.

The egg yolk product and the egg white egg yolk combination product has similar characteristics and requirements as the egg white product.

By the term “uniform” the Applicant intends that there is a mechanical treatment of the egg product brought about by agitation, which processes the fluid. The egg white fluid is about 90% water, and about 10% protein. When any process done is normally performed on the egg white, such as mixing, the water tends to get separated from the protein and this creates a problem for creating a uniform product. In the disclosure mixing and blending avoids separation. This would be especially the situation when the egg white is pasteurized, a lot of air bubbles would otherwise be created. Air does not let the egg white get cooked in a confined closed package, because the air is trapped between the mix of water and protein and causes separation of protein from water in a final cooked product which would make the product unacceptable. Prior to this disclosure, there was no process or apparatus to remove air from egg white. The egg white treated before the filling overcomes this problem. The blending is done accurately, and nearly all of the air will be taken away from the mix before the filling, and the rest of the air in the filling machine will be removed by a technique which will be applied when working with the machines. The process of cooking is carried out by heating, which may be in an oven, water bath, hot air or any form of heating that could bring the core temp of the tubes to a minimum of about 165° F. or higher, for example 185° F.

The process includes blending, which follows or is part of rendering the egg uniform egg white/egg yolk by a blending process of minimizing aeration and achieving uniformed liquid.

Cooking is affected by heating at a house temperature of 90° F. to 240° F. for about a time between one and three hours (depending on the size of casings) to reach core temp of 165° F. minimum, or as high as 185° F.

An egg white product is so conditioned that after cooking the egg white is soft and tender and is comparable in eating properties to a freshly cooked natural egg white/egg yolk.

Apparatus for filling in casing with egg white/egg yolk includes a filler nozzle that inserts into a shirred casing. It has one open end that disposes inside the joining device and inserted into the cylindrical member, and a clipping mechanism for closing the cylindrical member of the casing. The filler nozzle includes an inner filling nozzle for feeding the egg white into the cylindrical member.

There is a hopper for supplying egg white/egg yolk to the filler nozzle.

A process produces an egg white/egg yolk product from raw egg. These are separated egg constituents. There are the steps of informing liquid egg white or egg yolk, applying blending to achieve and maintain the uniformed egg white and reduce aeration of the uniformed egg white/egg yolk, filling casings with the uniformed egg white/egg yolk, and cooking the non-aerated uniformed egg white/egg yolk in the casing, without adding any additives or food fillers. Salt, which may be added for taste is not considered as a filler in the present disclosure.

The process includes blending, which is the processed egg white/egg yolk by a process of blending to minimize aeration and achieve uniformed liquid. Blending is affected at a temperature between about 32° F. and about 43° F. and a speed between 500 rpm and 1000 rpm. Cooking is affected by heating at a house temperature of about 190° F. to 240° F. for about a time between one and three hours (depending on the size of casings) to reach core temp of 165° F. minimum or more up to 185° F.

An egg white product is so conditioned that after cooking the egg white is soft and tender and is comparable in eating properties to a freshly cooked natural egg white/egg yolk.

An apparatus for filling in casing with egg white/egg yolk includes a filler nozzle. It has one open end that disposes inside the joining device and inserted into the cylindrical member, and a clipping mechanism for closing the cylindrical member of the casing. The filler nozzle includes an inner filling nozzle for feeding the egg white into the cylindrical member.

There is a hopper for supplying egg white and/or egg yolk to the filler nozzle.

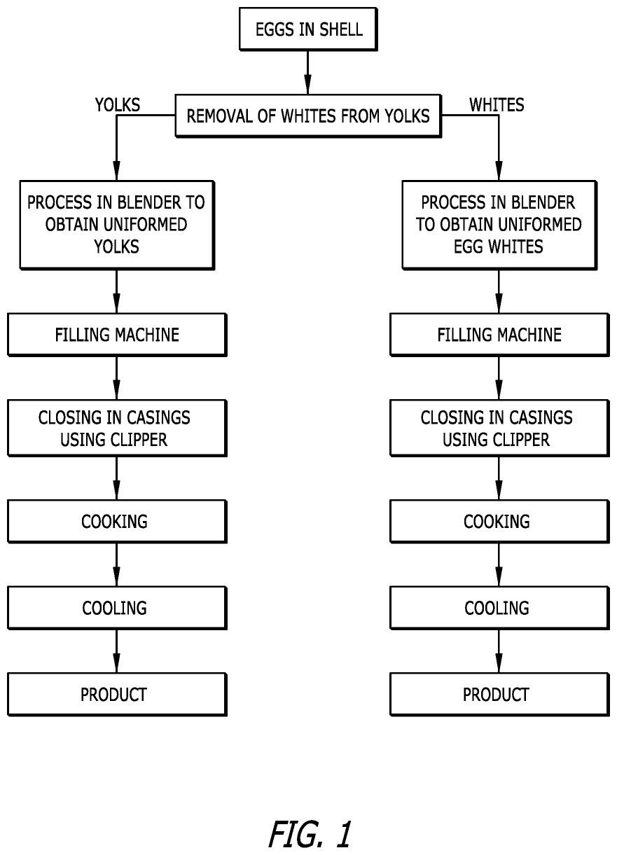

The general procedure illustrated in FIG. 1 is as follows: Fresh egg whites are removed from their shells in step 1, and in step 2 the whites are separated from the yolks by conventional methods. The whites are shown being processed 3. As will be presently explained, the processing involves certain operations, including pasteurizing in the event the source materials are not previously pasteurized.

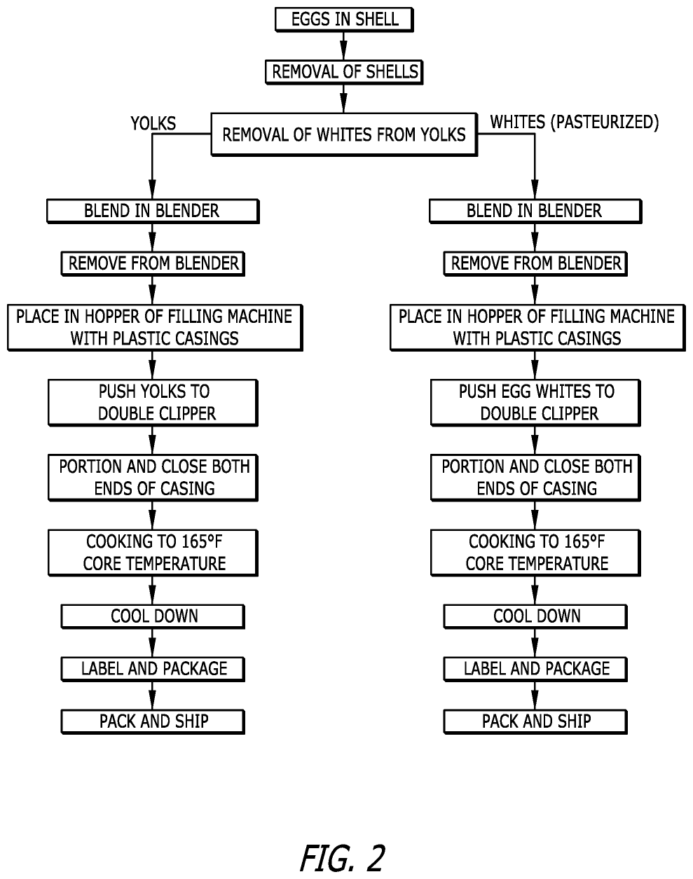

A process of the character shown in FIG. 2. In this instance the removal of egg whites from their shells and the separation of whites from whites is the same as in FIG. 1.

The bodies forming Products can be marketed as Ready to Eat even without reheating or re cooking and used for a variety of purposes.

Particularly when commercial pasteurized egg white/egg yolk material is used. Instead of fresh egg whites as source material it is possible to make use of commercial or refrigerated egg white, which is available in containers.

Assuming that time and temperature factors are properly controlled during the cooking cycle, the cooked egg white has good eating properties. Particularly, it does not have an off flavor and the white portion is soft and tender. In general, the cooked product has properties such as palatability, tenderness, appearance, texture, flavor, and mouth feel comparable to a natural cooked egg white/egg yolk. The cooked egg white is perfect for slicing, dicing or any forms of cuts that will not easily fall apart with conventional methods of slicing, dicing, or cutting.

The characteristics described above enhance the value of such products for domestic, institutional, restaurants, end consumer and even international markets use. Particularly, the egg white product slices can be placed upon one half of a bun with or without additional edible material such as slices of cheese or meat, or any condiments.

With respect to cooking together with other food materials, bits of other foods, such as cooked ham, bacon, sausage, or cheese, may be added after blending and before filling. and thereby incorporated with the egg white. For example, food slices may be disposed below and on the upper surface of the egg white material, separating contact between the bun dough and the egg white.

In case the product consumer would like to reheat in a microwave oven, it can also be reheated in other conventional ways, such as steaming, frying, poaching, exposure to infrared heat lamps, or in a hot air oven.

With respect to cooking complete egg white/egg yolk products in a microwave oven, it is advantageous to make up bun assemblies or sliced bread sandwiches with an egg white assembly, with or without other foods, such as sliced cheese and ham. These can then be stored in a freezer. When distributed to point of use or sale they may be transferred to a refrigerator for thawing and any further storage before being eaten cold or after heating as in a microwave oven. Thawing may also be carried out by ambient exposure. Aside from microwave cooking, other reheating methods can be used, such as frying, oven baking, boiling in water, or exposure to saturated steam at atmospheric pressure while in a plastic heat resistant film bag.

The source of egg white material may likewise be either fresh, frozen, refrigerated, or if it is frozen, first thawed, before further processing.

Also, reference has been made to carrying out pasteurization when the source materials are fresh egg white, and when the refrigerated or materials have not been pasteurized. Pasteurization can be carried out as a separate step preceding blending. However, with certain types of equipment, for example continuous flow heat exchange equipment, pasteurization can be carried out in one operation with proper control of temperature and time periods.

A filling apparatus of egg white shown in figures automatically and continuously fills a film casing with egg white/egg yolk having a certain degree of viscosity such as raw egg white separated into white and yolk.

A filler nozzle is formed of a double pipe including an inner pipe forming a filling nozzle for feeding egg white and/or egg yolk and an outer pipe preventing forming air in the nozzle. A top end of the filling nozzle is connected to the clipping machine.

The raw egg white is fed into the hopper and into the filling machine. At this time, the quantity of the egg white in the hopper is adjusted automatically by the opening and closing of the valve controlled by PLC of the filler. The plastic casing, which is layered, is continuously fed by pushing the egg white/egg yolk coming from the filling machine into the casing. Then the feed is subjected to a double clipper machine that closes both ends of the casings using metal clips. Closing is done by pushing down the handle of the clipping machine or it could be automatically performed. This pushes down a stainless-steel jaw that folds and clamps the plastic casing, preparing it to apply the aluminum clips around the folded and clamped casing, and secures the closing of the casing by pressure regulated by a double clipper machine. This will prevent any air or bacteria from penetrating the casing and secures the safety of the egg white during and after the process.

After the completion of the clamping operation, the already packed and ready to cook tubes of egg white/egg yolk are connected to each other. Then ready to be cooked. The tubes can be cooked separated from each other or all together as in pairs of beads. Cooking should be at an oven temp of 190° F. to 240° F. and the core temp of the tubes should be not less than 165° F. or more up to 185° F.

The egg white is not limited to raw egg white, and the filling apparatus of the present disclosure can attain the same operation and effect as described above even if the egg white is another kind of egg white.

A time difference in the opening and closing operation between the squeezing, clipping, and closing is determined by the filler servo motor, which is accurate and performed automatically, adjustable by PLC of the filling machine.

As described above, according to the present disclosure, the filler nozzle is formed of a stainless-steel bar inserted to the filling nozzle. The outer nozzle moves with the signal of the filler backwards when the action of filling is performed, this allows the flow of egg white, and moves forward when the action of filling is performed. Between the inside bar and the nozzle, there is a tiny space through which the egg white flows. At the tip of the nozzle and the bar, where both bar and nozzle end, there is a sealing part that stops the flow of the egg white when the filler machine sends the signal to stop, and actually the nozzle moves forward. This prevents the entering of air to the casings, and the portioning of each casing will be accurate. Further, since the valve coupling to the nozzle is opened and closed in synchronism with the operation of the squeezing jaw performed by clipping machine, the increased pressure in the cylindrical casing member can be adjusted by the squeezing operation of the squeezing jaw of the clipping machine and air contained in the cylindrical member can be exhausted prior to the squeezing operation. In addition, since air can be prevented from entering into the film casing in the case where the egg white is raw egg white, it can be preventing that egg white hardened by the heating.

Pressure can be adjusted to properly increase the pressure in the casing is performed by the filling machine, preprogrammed and adjustable in the filling machine, and carried out to the clipper machine.

Egg whites prepared by this process showed substantially complete coagulation by heating in the casing and were consumer desirable. A consumer can eat the product by heating for a short time in a microwave oven (as wished), or, etc.

Egg whites prepared by this process showed substantially complete coagulation by heating in the casing and were consumer desirable. A consumer can eat the product by heating it for a short time in a microwave oven (as wished), or it may be eaten cold. In some cases, different vegetable additions can be added, for instance mushroom or chili, etc. These may be prepared and added prior to heating in the casing.

### EXAMPLES

1 A batch of egg white was prepared and treated as follows:
   a. Volume: 40 lbs. No blending and directly feeding into the filling machine. temperature 38° F.
   b. Uniform properties are measured so that the consistency was unacceptable.
   c. Non-aeration measured as having significant parts of air relative to volume.
   d. Nozzle fills 7 Oz product casings at a rate of 1000 rpm.
   e. Cooking of casing effected in an oven with 40% steam at 200° F. for 2 hours.
   f. The result was totally unacceptable, as there was too much air in the casings.
2 A batch of egg white was prepared and treated as follows:
   a. Volume: 40 lbs.
   b. Uniformed in a blender for 5 minutes and temperature 37° F.
   c. Uniform properties measured so that the consistency was acceptable.
   d. Non-aeration measured as having little parts of air relative to volume.
   e. Nozzle fills 7 Oz product casings at a rate of 1000 rpm.
   f. Cooking of casing effected in an oven with 40% steam at 200° F. for 2 hours.
   g. Result was not acceptable. A little air in the casings.
3 A batch of egg white was prepared and treated as follows:
   a. Volume: 40 lbs.
   b. Uniformed in a blender for 2 minutes- and temperature 36° F.
   c. Uniform properties measured so that the consistency was acceptable. We checked the casings both visually and tactile before cooking and no air was detectable . . . after cooking the result came out very much acceptable.
   d. Non-aeration measured as having nearly 0% parts of air relative to volume mentioned above
   e. Nozzle fills 7 Oz product casings at a rate of 500 rpm.
   f. Cooking of casing effected in an oven with 40% steam at 200° F. for 2 hours.
   g. The Result was acceptable. Nearly No air in the casings, after cooking the very tiny particles of air in the product was seen but the percentage was too little that could not affect the consistency of the egg white and the result was very good.
4 A batch of egg yolk was prepared and treated as follows:
   a. Volume: 40 lbs.
   b. Uniform in a blender for 2 minutes and temperature 35° F.
   c. Uniform properties measured so that the consistency was Satisfactory.
   d. Non-aeration measured as having 0% parts of air relative to volume.
   e. Nozzle fills 7 Oz product casings at rate of 500 rpm.
   f. Cooking of casing effected in an oven with 40% steam at 200° F. for 2 hours.
   g. The Result was acceptable. No air in the casings.
5 A batch of egg white and yolk was prepared and treated as follows:
   a. Volume: 20 lbs. white and 20 lbs. yolk
   b. Uniform in a blender for 2 minutes and 37° F.
   c. Uniform properties measured so that the consistency was satisfactory.
   d. Non-aeration measured as having 0% parts of air relative to volume.
   e. Nozzle fills 7 Oz product casings at rate of 500 rpm.
   f. Cooking of casing effected in an oven with 40% Steam at 200° F. for 2 hours.
   g. The Result was acceptable. No air in the casings.

In the specification, there have been disclosed typical embodiments of the disclosure. Although specific terms are employed, they are used in a generic and descriptive sense only and not for purposes of limitation, the scope of the disclosure being set out in the claims. For instance, there may be different techniques for blending the egg product and for removal of air from the egg product prior to filling the casing. These techniques may take place in a single operation or step or in multiple operations or steps. For instance, other forms of immersion blending device and/or elements can develop the necessary liquid egg dispersion and reduction of entrapped air in the liquid to create the necessary uniform product prior to filling in the casing. Creating a film of the liquid egg product as the product passes through the blender creates a requisite product suitable for passage to the filler and the casing. Although the casing is relatively easy to fill because of its round shape, the concept of the disclosure is to include placing the egg fluid in other shapes and formats of packing so long as the packing is airtight. The end product should be one where the cooked egg is contained in an airtight packing. In some cases, the cooking is pre done at least in part before filling the packing with the egg product which packing is then rendered airtight with the egg product. It is therefore to be understood that within the scope of the appended claims the disclosure may be practiced otherwise than as described.

1. A process for producing an egg white product being free of egg yolk from liquid egg white, the liquid egg white being free of egg yolk comprising the steps of blending liquid egg white to form a uniformed liquid egg white, applying the blending to the liquid egg white prior to filling the liquid egg white in a packing, reducing aeration of the blended uniform liquid egg white to obtain a de-aerated uniform liquid egg white, filling the packing with blended de-aerated liquid egg white, sealing the packing to prevent aeration of the blended liquid egg white, the blended liquid egg white being free of egg yolk, and cooking the uniform blended de-aerated, liquid egg white, the liquid egg white being free of egg yolk in the sealed packing, and the cooked product being free of egg yolk including filling the packing through a nozzle and squeezing the packing to remove aeration prior to sealing the package, opening and closing the nozzle in synchronism with the squeezing of the packing and the cooking being carried out by heating at a temperature to reach a minimum of 165° F., and wherein the product is free of food fillers, being at least one of starch, flour, or gum, such that the cooked egg white product in the sealed casing consists of an edible solid egg white product.

2. (canceled)

3. A process as claimed in claim 1 in which the liquid egg white is blended and agitated to minimize aeration, the measure of aeration being between about 0% air relative to a volume of liquid egg white and not more than 8% in a volume of liquid egg white, and the packing is airtight around the egg white.

4. A process as claimed in claim 1, including blending at a temperature between about 32° F. and about 43° F. and at a speed between 500 rpm and 1000 rpm.

5. A process as claimed in claim 1, including cooking by heating to reach a core temperature of 165° F. of the product in the packing.

6-18. (canceled)

19. A process as claimed in claim 1, wherein the product is free of at least two of starch, flour, or gum.

20. A process as claimed in claim 1, wherein the product is free of preservatives, and the product includes salt.

21. The product produced by the process of claim 1.

22. The product produced by the process of claim 14.

23. (canceled)

24. A process for producing an egg white product being free of egg yolk from liquid egg white, the liquid egg white being free of egg yolk, and the liquid egg white being constituted by egg protein and water comprising the steps of blending liquid egg white to form a uniformed liquid egg white, the blending of the liquid egg white being prior to filling the liquid egg white in a packing, the blending being effected by passing the liquid egg white through rotating gears in a blender, the gears pushing the liquid egg white against surfaces of the gears, spreading the egg white protein with the water in the liquid egg white against a surface thereby to achieve a uniform mix of the non-aerated liquid egg white, filling the uniformed mix of de-aerated liquid egg white in a packing, the filling action being a process to prevent aeration of the uniformed liquid non-aerated liquid egg white, sealing the packing to prevent aeration of the uniformed de-aerated liquid egg white, and then cooking the uniform de-aerated, liquid egg white in the sealed packing, the uniformed de-aerated liquid egg white being free of egg yolk; and the cooked product being free of egg yolk, such that the cooked egg white product in the sealed casing consists of an edible solid egg white product.

25. A process as claimed in claim 24 including squeezing the packing prior to sealing thereby to exhaust residual air in the packing, and thereafter clipping ends of the packing closed and sealed to prevent aeration.

26. A process as claimed in claim 1 wherein the packing is a casing.

27. A process as claimed in claim 24 wherein the packing is a casing.

28. A process as claimed in claim 1 including squeezing the packing prior to sealing thereby to exhaust residual air in the packing, and thereafter clipping ends of the packing closed and sealed to prevent aeration.

29. A process as claimed in claim 1, including blending at a temperature between about 32° F. and about 43° F. and at a speed between 500 rpm and 1000 rpm, and including filling the packing through a nozzle and squeezing the packing to remove aeration prior to sealing the package, opening and closing the nozzle in synchronism with the squeezing of the packing and including cooking by heating to reach a core temperature of 165° F. or more of the product in the packing.

30. A process as claimed in claim 24, including blending at a temperature between about 32° F. and about 43° F. and at a speed between 500 rpm and 1000 rpm, and including cooking by heating to reach a core temperature of 165° F. or more of the product in the packing.

31. A process for producing an egg white product consisting of the steps of blending liquid egg white to form a uniformed liquid egg white, applying the blending to the liquid egg white prior to filling the liquid egg white in a packing, reducing aeration of the blended uniform egg white to obtain a non-aerated uniform egg white, filling the packing with blended de-aerated liquid egg white, sealing the packing to prevent aeration of the blended liquid egg white, and cooking the uniform blended de-aerated, liquid egg white, such that the cooked product in the sealed package consists of the egg white product, the product consists of an edible solid egg white product.

32. A process for producing an egg white product comprising of the steps of blending liquid egg white to form a uniformed liquid egg white, applying the blending to the liquid egg white prior to filling the liquid egg white in a casing with [normally] two open ends when unfilled, reducing aeration of the blended uniform egg white to obtain a de-aerated uniform egg white, filling the casing with blended de-aerated liquid egg white, sealing the casing at the two open ends to prevent aeration of the blended liquid egg white, and cooking the uniform blended de-aerated, liquid egg white in the sealed casing, such that the cooked egg white product in the sealed casing consists of an edible solid egg white product.

33. A process for producing an egg white product as claimed in claim 32 wherein there is only a single cooking step prior to creating the edible egg white product.

34. A process as claimed in claim 31 wherein the packing is a casing.

35. A process as claimed in claim 34 wherein the casing [normally] includes two open ends when unfilled, and including sealing the casing at the two open ends to prevent aeration of the blended egg white product.
